(19) United States
(12) Patent Application Publication
(10) Pub. No.: US 2026/0346780 A1
(43) Pub. Date: Nov. 5, 2026

(54) An Item Carrying Device For a Vehicle

(71) Applicant: Rhino Rack Australia Pty Limited, Eastern Creek (AU)

(72) Inventor: Alexander Nguyen, New South Wales (AU)

(21) Appl. No.: 19/124,656

(22) PCT Filed: Sep. 21, 2023
(86) PCT No.: PCT/AU2023/050912

§ 371 Date: Apr. 25, 2025

(30) Foreign Application Priority Data
Oct. 27, 2022 (AU) 2022903185

(51) Int. Cl. B60P 7/08; A44B 11/12; B60R 9/048

(52) U.S. Cl. CPC B60P 7/0838; A44B 11/125; B60R 9/048

(57) ABSTRACT

An item carrying device for a vehicle is described, the device including: a strap which is provided with a series of projections; and a ratcheting buckle; the buckle receives the strap and includes a ratcheting mechanism which is operable to engage with the projections to progressively draw the strap through the buckle and also to retain the strap in the buckle; the buckle further includes a release mechanism which is operable to release the strap from the buckle.

### TECHNICAL FIELD

This disclosure relates in general to item carrying arrangements for vehicles and particularly relates to an item carrying devices used in arrangements for carrying items on vehicles.

### BACKGROUND TO THE DISCLOSURE

Sometimes it is desirable to transport an item on the outside of a motor vehicle. The item may be too bulky to fit inside the vehicle, or it may be desired to use available storage space within the vehicle for other purposes. An item carrying arrangement can be used which is affixed to the vehicle and is adapted to hold or restrain the item. Examples include tie down straps or screw down fixtures which may be used in connection with a roof rack of a vehicle.

It has been tried to use tie down straps made from nylon or polyester webbing to carry items on vehicles. A buckle is used to secure the straps around the item to secure the item to the vehicle. However, the straps may be quite easily cut through using a box cutter or utility knife and so the items secured in this way are vulnerable to theft.

There remains a need for improved item carrying arrangements for vehicles.

### SUMMARY OF THE DISCLOSURE

In a first aspect the present disclosure provides an item carrying device for a vehicle including: a strap which is provided with a series of projections; and a ratcheting buckle; the buckle receives the strap and includes a ratcheting mechanism which is operable to engage with the projections to progressively draw the strap through the buckle and also to retain the strap in the buckle; the buckle further includes a release mechanism which is operable to release the strap from the buckle.

The device may further including a locking mechanism which can be operated to put the buckle into a locked mode in which the strap release mechanism is prevented from being operated to release the strap.

When the locking mechanism is in the locked mode the ratcheting mechanism may remain operable to tighten the strap.

The locking mechanism may include a moveable bolt which, in the locked mode, obstructs the movement of the strap release mechanism.

The projections of the strap may have a sawtooth profile.

The strap may have a metal core and the projections may be formed from a plastic material.

The ratcheting mechanism may include a pawl which engages with the projections to retain the strap in the buckle.

The strap release mechanism may be operable to disengage the pawl from the projections of the strap.

The strap release mechanism may include a pawl release linkage which is pivotally mounted to the body of the buckle and which is rotatable to release the pawl from the strap.

The ratcheting mechanism may include an operating handle which is pivotally mounted to the pawl release linkage and which is rotatable to draw the strap into the buckle.

The operating handle may include at least one projection which is engageable with at least one of the projections of the strap to draw the strap through the buckle.

The operating handle may also be operable to rotate the pawl release linkage to release the pawl from the strap.

The operating handle maybe operated to rotate the pawl release linkage by lifting the operating handle so that its axis of rotation moves in a direction away from the strap.

The device may further include a bracket to which the strap and the buckle are attached, the bracket being arranged to affix to a vehicle.

The buckle may be attached to the bracket by way of a second strap.

The bracket may include at least one fold-out portion which can be folded out to assist in supporting an item being carried in use.

In a second aspect the present disclosure provides a vehicle fitted with an item carrying device according to any preceding claim.

### BRIEF DESCRIPTION OF THE DRAWINGS

Embodiments will now be described, by way of example only, with reference to the accompanying drawings, in which:

FIG. 1 is a perspective view of a device for carrying an item on a vehicle;

FIG. 2 is a rear perspective view of the device of FIG. 1;

FIG. 3 is a side view of the device of FIG. 1;

FIG. 4 is a top perspective view of the buckle of the device of FIG. 1;

FIG. 5 is an underside perspective view of the buckle of FIG. 4;

FIG. 6 is a side view of the buckle of FIG. 4;

FIG. 7 is a cross-sectional view of the buckle region of the device of FIG. 1;

FIG. 7A is detail B of FIG. 7;

FIG. 7B is detail C of FIG. 7;

FIG. 8 shows the buckle of FIG. 7 in an unlocked condition being operated to tighten the strap;

FIG. 8A is detail B of FIG. 8;

FIG. 8B is detail C of FIG. 8;

FIG. 9 shows the buckle of FIG. 7 in an unlocked condition being operated to release the strap;

FIG. 9A is detail B of FIG. 9;

FIG. 9B is detail C of FIG. 9;

FIG. 10 shows the buckle of FIG. 7 in a locked condition and an unsuccessful attempt being made to release the strap;

FIG. 10A is detail B of FIG. 10;

FIG. 10B is detail C of FIG. 10;

FIG. 11 shows the buckle of FIG. 7 in a locked condition and also being operated to tighten the strap;

FIG. 11A is detail B of FIG. 11;

FIG. 11B is detail C of FIG. 11;

FIG. 12 shows the device of FIG. 1 in an open configuration;

FIG. 13 is a perspective view showing two devices of FIG. 1 being used to carry a stack of recovery tracks on a vehicle; and

FIG. 14 is a front view of the vehicle of FIG. 13.

### DETAILED DESCRIPTION OF EMBODIMENTS

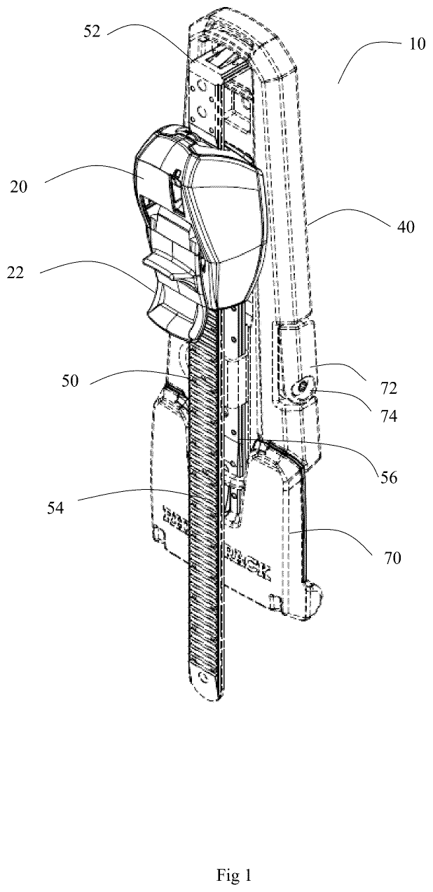

Referring to FIG. 1 an item carrying device 10 for a vehicle is shown including a toothed strap 50 which is attached at one end 52 to a bracket in the form of backplate 40. Strap 50 has a series of projections in the form of teeth 54 which have a sawtooth profile. The strap is formed with a steel core which has been over moulded with region of polyester elastomer to surround the core. The teeth are formed in the region of polyester elastomer.

Device 10 further includes a buckle 20 which receives the strap 50 by inserting the strap into an aperture through the buckle. The buckle includes a ratcheting mechanism which is operable to engage with the teeth 54 to progressively draw the strap through the buckle 20 and also to retain the strap 50 in the buckle 20. The buckle further includes a release mechanism which is operable to release the strap from the buckle. Both of the ratcheting mechanism and the release mechanism are operated by way of arm 22. Buckle is attached to the lower region of bracket 40 by a shorter fixed strap 56.

Bracket 40 includes two fold out portions. Leg 72 is rotatable about pivot point 74 and can be folded outwardly in use to assist in supporting a ladder or other item that may be carried in the device. Another fold out portion is provided in the form of fold out shelf 70 which can be used to support items which may be held in the device, such as one or more recovery tracks as will be later described.

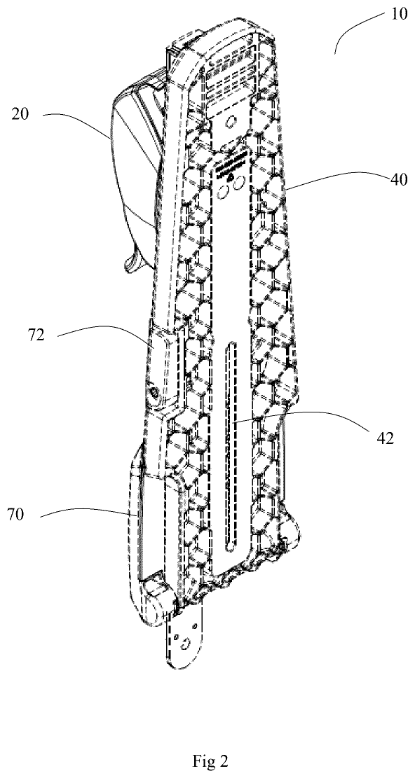

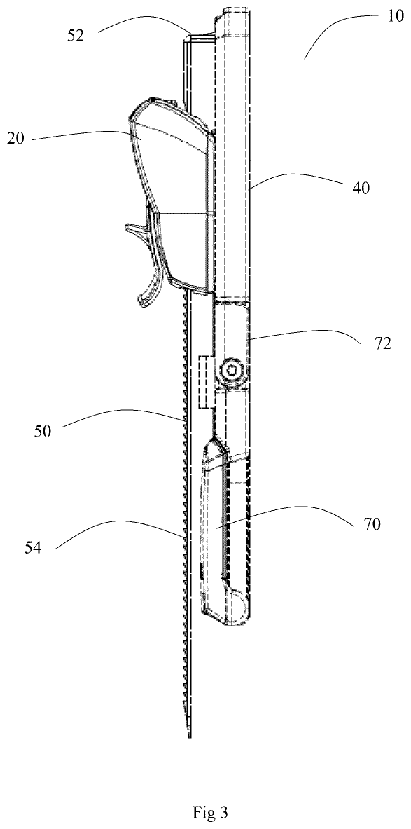

As best seen in FIG. 2, bracket 40 is arranged to be attached to a mounting piece (not shown) by way of elongate slot 42. The mounting piece can be attached at any position along the slot to provide for height adjustment of the bracket. The mounting piece is then in turn attached to a vehicle, or to the roof rack of a vehicle to mount the bracket to the vehicle.

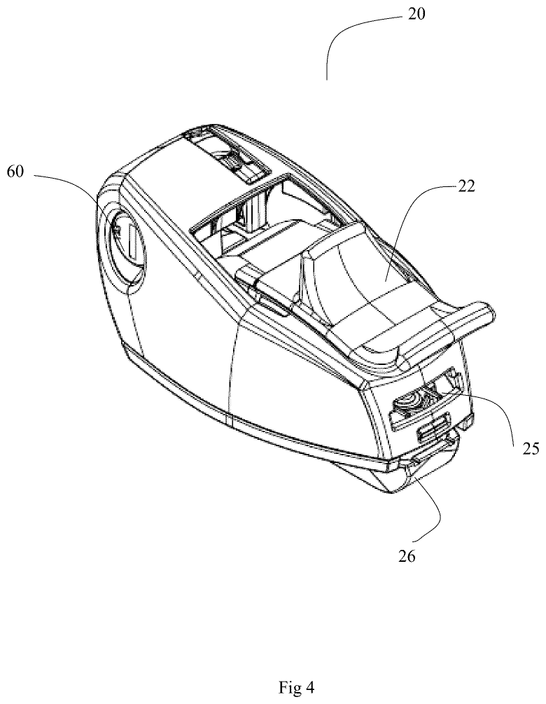

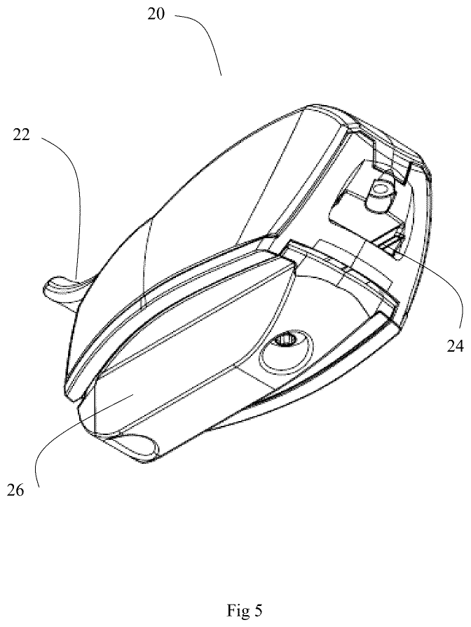

Referring to FIGS. 4 and 5, buckle 20 is shown in isolation. A locking mechanism of the buckle includes a lock barrel 60 which can be operated with a key.

Moveable strap 50 is received in the buckle 20 in use by inserting the free end of the strap 50 into front aperture 24 and the strap emanates from rear aperture 25.

Sled 26 creates a lower profile of the buckle which assist in retaining certain types of items in the device as will be later described.

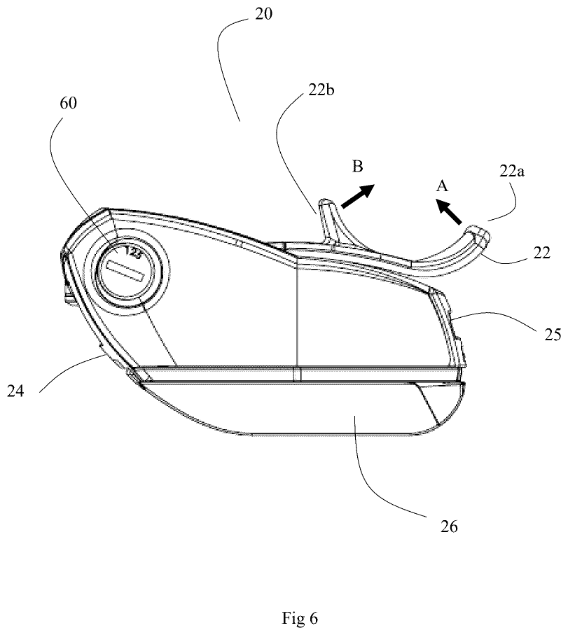

Referring to FIG. 6, arm 22 is operable in two modes. By grasping formation 22a and rotating the arm in the direction of arrow A the arm operates the ratcheting mechanism of the device, to draw the strap 50 into the buckle 20. By grasping formation 22b and lifting the arm in the direction of arrow B, the arm operates the strap release mechanism of the buckle which allows the strap 50 to be withdrawn from the buckle 20.

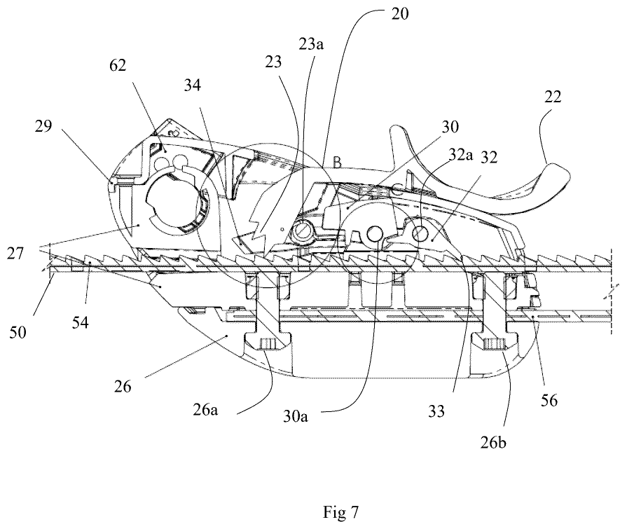

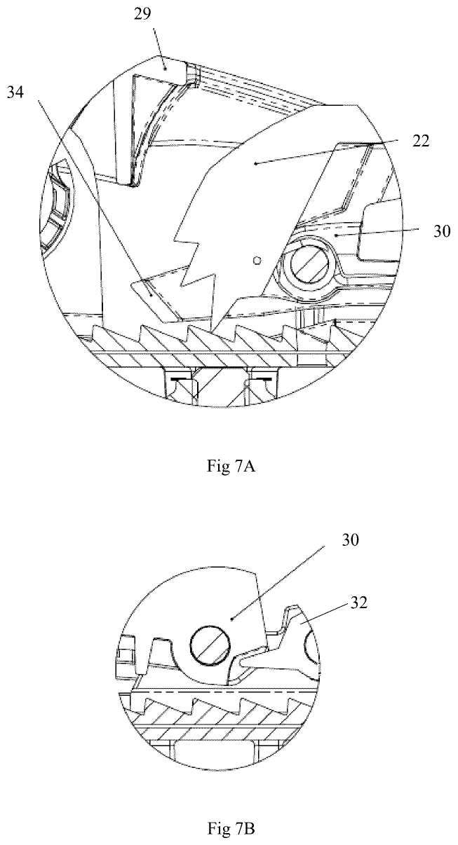

Referring to FIGS. 7, 7A and 7B, buckle 20 is shown in cross sectional view in its resting position in with the strap 50 received and retained in the buckle. Buckle 20 includes a base 27 and sled 26 is affixed the base 27 with two screw fasteners 26a, 26b which also serve to retain the fixed strap 56 to the buckle, which in turn attaches the buckle 20 to the bracket 40 (not shown).

The ratcheting mechanism of buckle 20 includes an operating handle in the form of arm 22 which is provided with a series of teeth 23. Arm 22 is pivotally mounted to a pawl release linkage in the form of middle body 30 at pivot pin 23a. A coil spring is fitted around pivot pin 23a which biases arm 22 to the position shown in FIG. 7.

The ratcheting mechanism further includes a pawl 32 which is pivotally mounted to base 27 at pivot pin 32a. A coil spring is fitted around pivot pin 32a and biases the pawl 32 to the position shown in FIG. 7 where the point 33 of the pawl 32 engages with a tooth 54 of the belt 50 to retain the belt in the buckle.

Middle body 30 is pivotally mounted to base 27 at pivot pin 30a. There is no torsion spring around pin 30a which biases it to the resting position. Rather, it is the combination of the torsion springs on pivot pins 32a and 23a in the assembly that biases the middle body 30 to the resting position seen in FIG. 7.

The base 27, sled 26 and cover 29 may be formed from a moulded plastic material. The pivot pins 23a, 32a, 30a, bias springs and pawl 32 may be formed from metal.

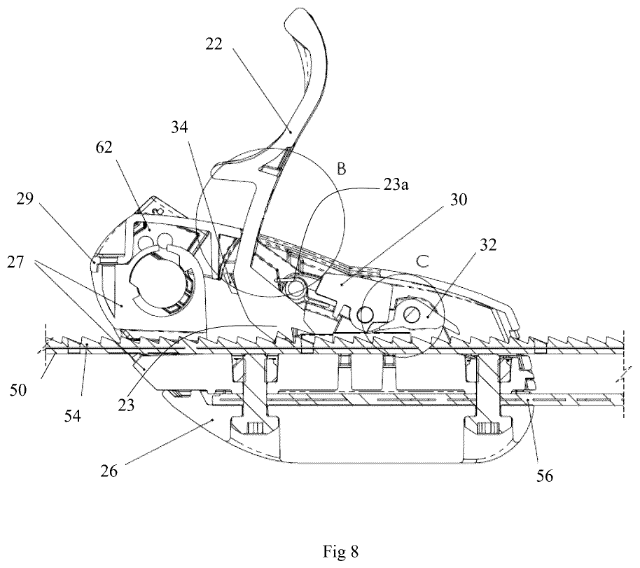

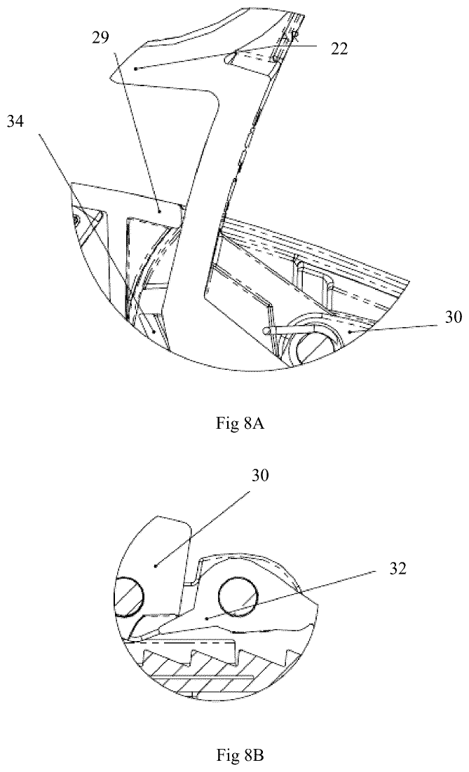

Referring to FIGS. 8, 8A and 8B, the ratcheting action of the buckle is illustrated. Arm 22 has been rotated about pivot pin 23a to its fullest extent, where the shaft of the arm 22 abuts case 29 (see detail B). The teeth 23 of the arm have engaged with the teeth 54 of strap 50 and drawn the strap further through the buckle. When the arm 22 is released, it will return to its home position as shown in FIG. 7 under the influence of the coil spring around pivot point 23a and pawl 32 will retain the strap in its new position 50 by engagement with teeth 54. By repeatedly rotating arm 22 between the positions shown in FIGS. 7 and 8 the strap 50 is progressively drawn through the buckle. This operation is carried out in use to tighten the strap 50 around an item to be carried.

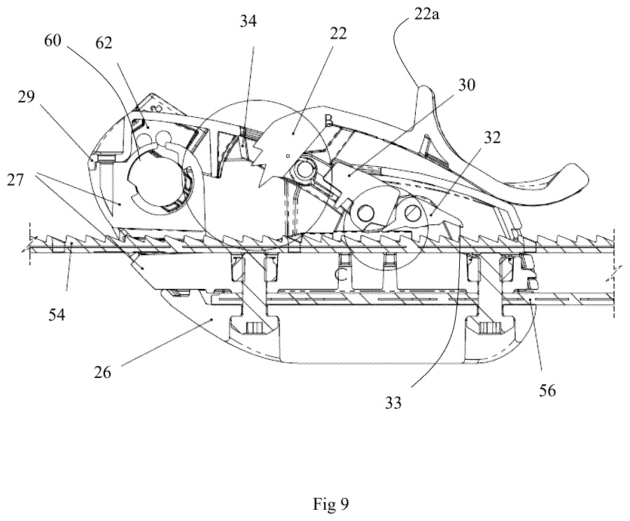

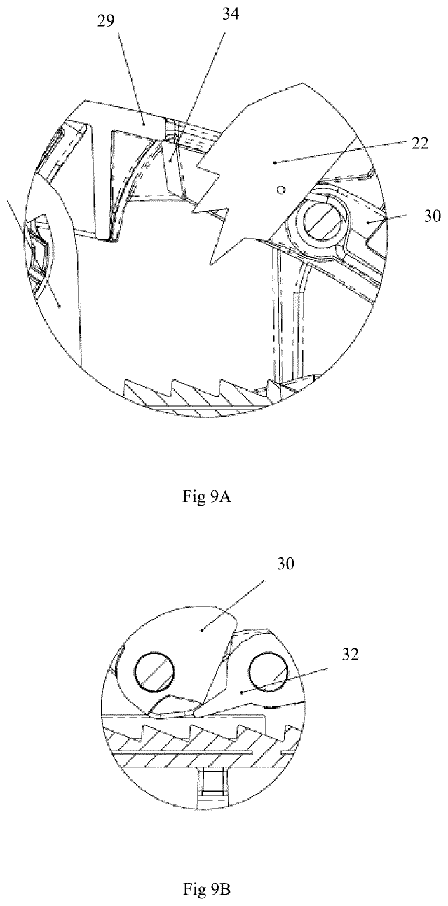

Referring to FIGS. 9, 9A and 9B, the pawl release action of the buckle is illustrated. Arm 22 has been grasped and lifted upwards in the direction B shown in FIG. 6. This causes the rotation of the middle body 30 against the force of its biasing coil spring. The middle body 30 in turn bears against the pawl 32 to rotate the pawl in an anti-clockwise direction as seen in the drawing against the force of its biasing spring. Arm 22 reaches its limit of upward movement when lip 34 abuts the inside of case 29 as seen in FIG. 9A. The point 33 of the pawl 32 has rotated away from the teeth 54 of strap 50 to such an extent that the strap 50 is no longer retained by the pawl 32. The strap 50 is now released and can be withdrawn from the buckle. In use, this operation is used to release the strap from around an item being carried to allow the item to be removed from the device.

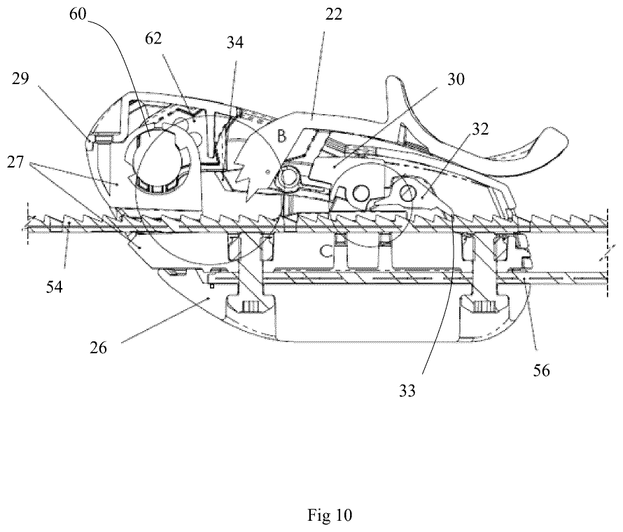

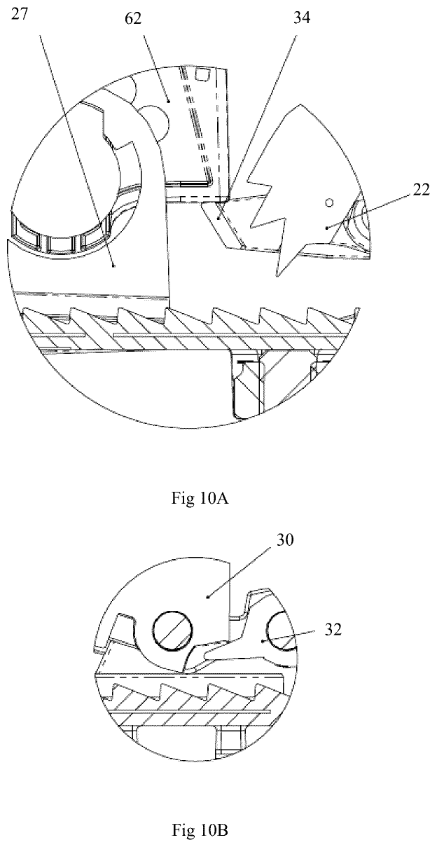

Referring to FIGS. 10, 10A and 10C, the locking mechanism of the buckle is illustrated. Lock barrel 60 carries a rotatable bolt 62. In FIG. 10, a key has been used to rotate the lock barrel and bolt to put the buckle 20 into its locked condition. Comparing the positions of the lock barrel 60 and bolt 62 between FIGS. 9 and 10 it can be seen that bolt 62 has rotated clockwise by about 55 degrees. The bolt 62 inhibits the movement of arm 22 to release the pawl 32. In FIG. 10, the arm 22 is being lifted towards the pawl release position in an attempt to release the pawl, however, the lip 34 has abutted bolt 62 which prevents the arm 22 from reaching the pawl release position. In the position shown in FIG. 10, the point 33 of pawl 32 remains engaged with one of teeth 54 and the strap is retained in the buckle.

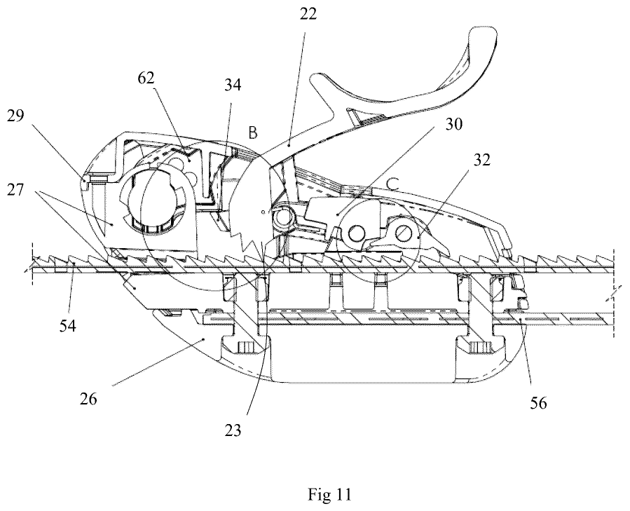

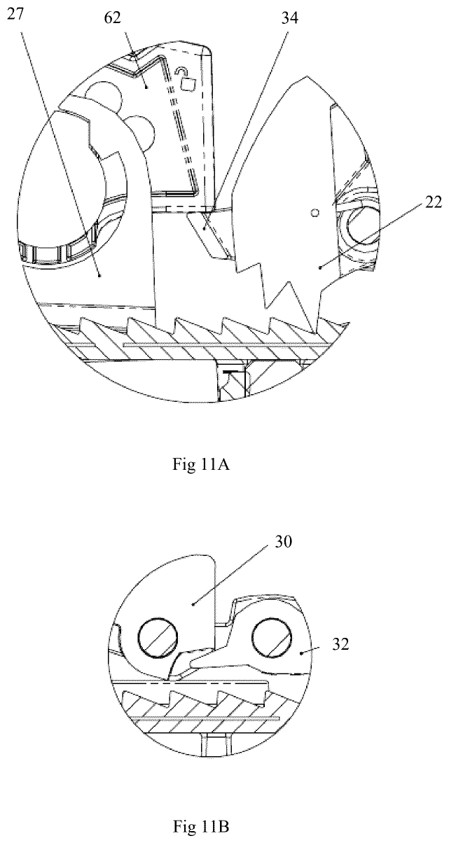

Referring to FIGS. 11, 11A and 11b, the buckle 20 is still in its locked condition and it is illustrated how the ratcheting mechanism remains operational when the buckle 20 is in this condition. In FIG. 11 arm 22 has been rotated to perform a ratcheting operation, to draw the strap into the buckle. The teeth 23 have engaged with teeth 54 to draw the strap to the right as seen in the figures and the strap is retained by pawl 32. The lip 34 has abutted bolt 62. If the arm were to be released, it would return under the force of its associated biasing spring to the rest position shown in FIG. 7. Repeated movements of the arm between the positions shown in FIGS. 7 and 11 effect a progressive tightening of the strap around an item to be carried in use. This enables the strap 50 to be tightened without the need to unlock the buckle and then re-lock the buckle.

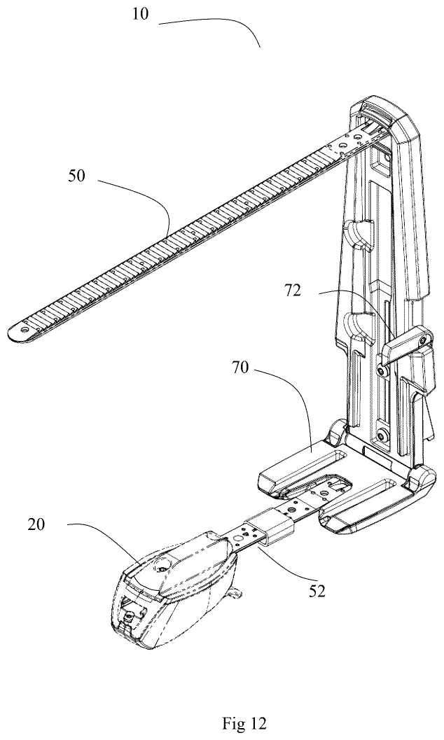

Referring to FIG. 12, the device 10 is shown in an open configuration, ready to receive an item to be carried, with strap 50 having been released from the buckle 20. Straps 50, 52 are sturdy but still somewhat flexible. Fold out leg 72 and shelf portion 70 are shown in their folded out configurations. Either or both of leg 72 and shelf 70 may be deployed in order to assist in supporting an item in the device 10.

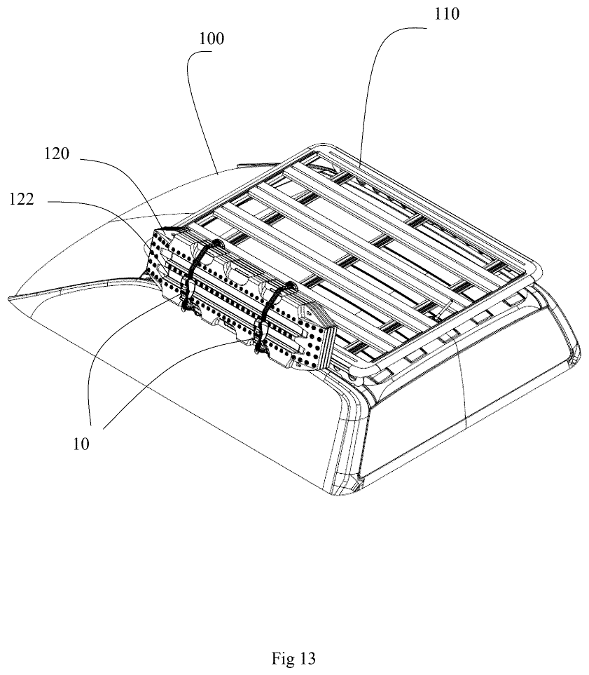

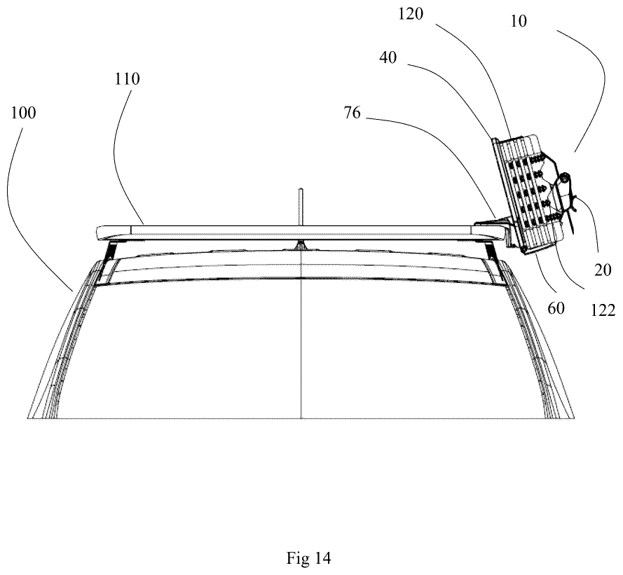

Referring to FIGS. 13 and 14, use of a pair of devices 10 will be described with reference to carrying a set of four recovery tracks 120 on a vehicle 100. Recovery tracks are a common item utilised by the 4 wheel drive off-roading community in the case that their vehicle is stuck in softer terrain and requires added traction to continue their journey. Recovery tracks take the form of rugged corrugated boards. If one or more wheels of a vehicle becomes bogged in loose ground, such as sand or mud, then recovery tracks are placed in front of the bogged wheels to provide a surface against which the wheel can achieve traction to drive the vehicle out of the bogged situation. Recovery tracks are usually carried on the outside of a vehicle stacked together in sets of two our four.

In FIGS. 13 and 14, a pair of devices 10 have been installed to a roof rack 110 of vehicle 100. The devices 10 are installed using generally L-shaped mounting pieces 76 which mount the devices 10 to the roof rack and provide height adjustment by way of the elongate slot 42 of the device 10.

To carry the recovery tracks, the toothed straps 50 of each device 10 are released from their respective buckles by activating the strap release mechanism of each buckle (FIG. 9) and withdrawing the straps 50. The fold out shelves 60 of each device are then folded out and the set of four recovery tracks is lifted up and rested on the two devices 10 being supported by the two fold out shelves 60 and resting against the bracket 40.

With the recovery tracks 120 in position the toothed strap 50 of each device is then inserted into the front aperture of its respective buckle 20 to emanate from rear aperture 25. The straps 50 can then be pulled through the buckles 20 by hand to take up slack in the straps. The pawl 32 of each buckle engages with the teeth on each strap 50 to retain the strap in the buckle.

The arm 22 of each buckle is then reciprocated to effect the tightening of the strap (repeating moving between the positions shown in FIGS. 7 and 8). The mechanical advantage provided by the arm 22 enables the strap to be tightened snugly around the recovery tracks. The arm is reciprocated until a desired tightness of the straps is achieved. The lock barrels 60 of each buckle 20 may then be key operated to put the buckles into their locked conditions.

The recovery tracks are now securely held in the devices 10. As best seen at FIG. 14, the sled 26 of each buckle engages with the outermost recovery track in the stack by nestling within an elongate recess which extends for the length of the recovery track. The vehicle may now be driven about with the recovery tracks securely held on the vehicle. Unauthorised removal or theft of the recovery tracks is prevented by the locking mechanisms. In addition, the straps 50 are very sturdy, and cannot be easily severed or otherwise cut through.

After a time of driving the vehicle, the stack of recovery tracks may settle in position giving rise to a degree of slack in the straps 50. If this is noticed by the user, such as at a rest stop on a journey, then the arms of the buckles can be operated to further tighten the straps. This can be done even when the buckle is in its locked condition (FIG. 11). The user does not need to find the keys and unlock the buckles to perform this operation.

When the user wishes to use the recovery tracks then they are removed from the devices 10 by unlocking the buckles (if they were locked) and then operating the handles of each buckle to the pawl release position to release and withdraw the strap 50 from each buckle. The recovery tracks can then be lifted from the vehicle for use.

Whilst the devices 10 have been described above for use in carrying a stack of recovery tracks, they can be used for carrying other items. Fold out portion 72 is intended for use when carrying a step ladder using the device and in use supports a rung of the step ladder. Any other item about which the straps can be wrapped may also be held in the devices 10.

It can be seen that embodiments of the device have at least one of the following advantages:
The device cannot be easily compromised with a box cutter or utility knife, as is the case with using polyester straps or webbing.
The device can be tightened even when in the locked condition, obviating the need to locate a key and undo locks in order to tighten the load.
The device can be used to carry a range of items.

While the disclosure has been described with reference to exemplary preferred embodiments above, it will be appreciated by those of ordinary skilled in the art that it is not limited to those embodiments, but may be embodied in many other forms, variations and modifications other than those specifically described. This disclosure includes all such variation and modifications. The disclosure also includes all of the steps, features, components and/or devices referred to or indicated in the specification, individually or collectively and any and all suitable combinations or any two or more of the steps or features.

In this specification, unless the context clearly indicates otherwise, the word “comprising” is not intended to have the exclusive meaning of the word such as “consisting only of”, but rather has the non-exclusive meaning, in the sense of “including at least”. The same applies, with corresponding grammatical changes, to other forms of the word such as “comprise”, etc.

Other definitions for selected terms used herein may be found within the detailed description and apply throughout. Unless otherwise defined, all other scientific and technical terms used herein have the same meaning as commonly understood to one of ordinary skill in the art to which the disclosure belongs.

Any promises made in the present document should be understood to relate to some embodiments of the disclosure, and are not intended to be promises made about the invention in all embodiments. Where there are promises that are deemed to apply to all embodiments of the invention, the applicant/patentee reserves the right to later delete them from the description and they do not rely on these promises for the acceptance or subsequent grant of a patent in any country.

In the foregoing description of certain embodiments, specific terminology has been resorted to for the sake of clarity. However, the disclosure is not intended to be limited to the specific terms so selected, and it is to be understood that a specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. An item carrying device for a vehicle including:
a strap which is provided with a series of projections; and
a ratcheting buckle;
the buckle receives the strap and includes a ratcheting mechanism which is operable to engage with the projections to progressively draw the strap through the buckle and also to retain the strap in the buckle;
the buckle further includes a release mechanism which is operable to release the strap from the buckle.

2. An item carrying device according to claim 1 further including a locking mechanism which can be operated to put the buckle into a locked mode in which the strap release mechanism is prevented from being operated to release the strap.

3. An item carrying device according to claim 2 wherein when the locking mechanism is in the locked mode the ratcheting mechanism remains operable to tighten the strap.

4. A device according to either of claims 2 or 3 wherein the locking mechanism includes a moveable bolt which, in the locked mode, obstructs the movement of the strap release mechanism.

5. A device according to any preceding claim wherein the projections of the strap have a sawtooth profile.

6. A device according to claim 5 wherein the strap has a metal core and the projections are formed from a plastic material.

7. A device according to any preceding claim wherein the ratcheting mechanism includes a pawl which engages with the projections to retain the strap in the buckle.

8. A device according to claim 7 wherein the strap release mechanism is operable to disengage the pawl from the projections of the strap.

9. A device according to claim 8 wherein the strap release mechanism includes a pawl release linkage which is pivotally mounted to the body of the buckle and which is rotatable to release the pawl from the strap.

10. A device according to claim 9 wherein the ratcheting mechanism includes an operating handle which is pivotally mounted to the pawl release linkage and which is rotatable to draw the strap into the buckle.

11. A device according to claim 10 wherein the operating handle includes at least one projection which is engageable with at least one of the projections of the strap to draw the strap through the buckle.

12. A device according to either of claims 10 or 11 wherein the operating handle is also operable to rotate the pawl release linkage to release the pawl from the strap.

13. A device according to claim 12 wherein the operating handle is operated to rotate the pawl release linkage by lifting the operating handle so that its axis of rotation moves in a direction away from the strap.

14. A device according to any preceding claim further including a bracket to which the strap and the buckle are attached, the bracket being arranged to affix to a vehicle.

15. A device according to claim 14 wherein the buckle is attached to the bracket by way of a second strap.

16. A device according to either of claims 14 or 15 wherein the bracket includes at least one fold-out portion which can be folded out to assist in supporting an item being carried in use.

17. A vehicle fitted with an item carrying device according to any preceding claim.
